(19) United States
(12) Patent Application Publication
(10) Pub. No.: US 2016/0320226 A1
(43) Pub. Date: Nov. 3, 2016

(54) DETERMINING HEIGHT OF A LIQUID LEVEL INTERFACE IN A CONTAINER FROM ACOUSTIC SIGNAL OR ECHO TIME MEASUREMENT

(71) Applicant: SIEMENS INDUSTRY, INC., ALPHARETTA, GA (US)

(72) Inventors: Robert Schaefer, East Northport, NY (US); Stefan von Dosky, Karlsruhe (DE); Wolfgang Ens, Linkenheim (DE)

(21) Appl. No.: 14/860,889

(22) Filed: Sep. 22, 2015

Related U.S. Application Data
(60) Provisional application No. 62/154,983, filed on Apr. 30, 2015.

(51) Int. Cl. G01F 23/296

(52) U.S. Cl. CPC G01F 23/296

(57) ABSTRACT

An ultrasonic liquid level detector includes clamp-on transducers for a liquid level measurement by the clamp-on transducers instead of insertion type transducers. The ultrasonic liquid level detector measures a height of a liquid-liquid interface or a gas-liquid interface based on an acoustic attenuation of an acoustic pulse or a transit-time of the acoustic pulse using a pulse echo technique or a combination thereof.

### CROSS REFERENCE TO RELATED APPLICATIONS

This application claims the benefit of U.S. Provisional Application Ser. No. 62/154,983 entitled “CLAMP-ON ULTRASONIC TANK LEVEL INDICATOR,” filed on Apr. 30, 2015, the contents of which are hereby incorporated by reference herein in their entirety.

### BACKGROUND

1. Field

Aspects of the present invention generally relate to a liquid level detecting system including a pair of acoustic transducers such as clamp-on ultrasonic transducers capable of determining a height of a liquid level interface in a container from an acoustic signal or echo time measurement.

2. Description of the Related Art

In general, a liquid level detecting system is utilized to determine a height of a liquid level in a container such as a holding or processing tank. For instance, a determination of a liquid level is required in the case of an underground dispensing system for fuel or generally in the case of a container for dangerous substances. Many industries (such as the hydrocarbon, pharmaceutical, food and chemical industries) also store liquids in holding or processing tanks. The level of the liquid inside the tank is typically required to determine the quantity delivered or the rate of flow into or out of the tank. In most cases the tank will contain one liquid composition with an air/gas interface; however it is also possible to have an interface between two stratified liquids with dissimilar densities.

Some currently available solutions for measuring the liquid interface inside a holding tank are based on Guided Radar (TDR) or Capacitive Probes. However, both of these approaches have their disadvantages. The probes must be in contact with the media. The probe is subject to wear, fouling and deposits which can result in measurement errors. Radar based systems rely on a sharp interface with a minimum required difference in the dielectric constant for a reliable measurement. Capacitive probes have to be calibrated for the media to be measured. In some cases floating gauges may be used but they might easily fail.

The liquid level may also be detected by an ultrasonic level measuring system that includes a pair of acoustic transducers. For example, for the purpose of monitoring a fuel tank it determines the liquid level with the aid of an acoustic signal by measurement of ultrasonic pulses with acoustic transducers. An acoustic transducer is an electronic device used to emit and receive sound or acoustic waves or pulses. One type of acoustic transducer is an ultrasonic transducer which converts energy between electrical and acoustic forms of energy. Ultrasonic transducers are used in medical imaging, non-destructive evaluation, and other applications. An interface between two stratified liquids with dissimilar densities has proven to be the most challenging for commercially available ultrasonic level sensors.

Typically ultrasonic transducers based liquid level sensors or detection devices are inserted into either the top or bottom of a tank, exposing the seals and transducer material to potentially corrosive gases or liquids. This also makes it difficult to service the transducers without draining and purging the tank. Since the acoustic path between the top and bottom transducers is normal to a liquid-liquid interface or a gas-liquid interface there is low sensitivity to low reflecting layers (liquids with small differences in density and sound velocity).

Current liquid level sensors also have difficulty with applications involving the detection of the interface between two different liquids with different densities. Also since emulsification scatters the reflected acoustic signal the existing level sensors have difficulty in detecting a level of an emulsified liquid interface.

In the case of difficult installations (e.g. with multiple fluid interfaces) level meters often are trial and error tested. The installation of different meters per tank is also common in use, where the final level measurement is based on a weighted average of the individual measurements.

### SUMMARY

Briefly described, aspects of the present invention relate to a contactless, clamp-on ultrasonic measuring system and a method for determining a height of a liquid level in a container from an acoustic signal or echo time measurement. In particular, the clamp-on ultrasonic measuring system is configured for liquid level detecting. One of ordinary skill in the art appreciates that such a clamp-on ultrasonic measuring system can be configured to be installed in different environments where liquid level detection or monitoring may be used, for example to determine a height of a liquid-liquid interface within a container holding two liquids of different densities.

In accordance with one illustrative embodiment of the present invention, a method is described for determining a liquid level in a container having a wall with an exterior surface from an acoustic signal measurement. The method comprises measuring the acoustic attenuation of an acoustic signal travelling from a first transducer to a second transducer substantially through the wall of the container being in contact with a first liquid based on an acoustic impedance of the first liquid in contact with the wall of the container, wherein the first and second transducers are mounted on the exterior surface of the wall of the container. The method further comprises calculating a height of a gas-liquid interface or a liquid-liquid interface being indicative of a liquid level of the first liquid in the container based on the measured acoustic attenuation of the amplitude of the acoustic pulse signal.

Consistent with another embodiment, a method is described for determining a liquid level in a container having a wall with an exterior surface from an echo time measurement. The method comprises measuring a signal transit-time of an acoustic beam of an acoustic pulse signal travelled from a first transducer to a second transducer on a sound path being at an acute angle to a liquid surface of a liquid level of a first liquid in the container. The liquid surface indicative of a gas-liquid interface or a liquid-liquid interface. The first and second transducers are mounted on the exterior surface of the wall of the container. The method further comprises calculating a height of the gas-liquid interface or the liquid-liquid interface being indicative of the liquid level of the first liquid in the container based on the measured signal transit-time of the acoustic beam of the acoustic pulse signal.

According to yet another embodiment of the invention, an ultrasonic liquid level detector is provided. The detector includes a first transducer mounted on an exterior surface of a wall of a container capable of holding a first liquid and a second transducer mounted relative to the first transducer on the exterior surface of the wall of the container. The first transducer is configured to transmit an acoustic pulse signal substantially through the wall of the container being in contact with the first liquid or substantially to a liquid surface of a liquid level of the first liquid in the container. The liquid surface being indicative of a gas-liquid interface or a liquid-liquid interface. The second transducer is aligned to receive the acoustic pulse signal from the first transducer. The second transducer is configured to: receive the acoustic pulse signal travelled via the wall of the container to measure an acoustic attenuation of a signal amplitude of the acoustic pulse signal dependent upon an acoustic impedance of the first liquid in contact with the wall of the container to determine a height of the gas-liquid interface or the liquid-liquid interface being indicative of the liquid level of the first liquid in the container based on the measured acoustic attenuation of the signal amplitude of the received acoustic pulse signal or receive the acoustic pulse signal travelled from the liquid surface to measure a signal transit-time of an acoustic beam of the received acoustic pulse signal reflected from the liquid surface and travelled from the first transducer to the second transducer on a sound path being at an acute angle to the liquid surface to determine the height of the gas-liquid interface or the liquid-liquid interface based on the measured signal transit-time of the acoustic beam of the received acoustic pulse signal.

### BRIEF DESCRIPTION OF THE DRAWINGS

FIG. 1 illustrates a schematic of an ultrasonic liquid level detector to determine a height of a liquid-liquid interface from an acoustic signal measurement in accordance with an exemplary embodiment of the present invention.

FIG. 2 illustrates a schematic of a Lamb wave transducer of an ultrasonic liquid level detector of FIG. 1 in accordance with an exemplary embodiment of the present invention.

FIGS. 3A & 3B illustrate graphically measurements of an acoustic attenuation of signal amplitude of an acoustic pulse signal by a Lamb wave transducer of an ultrasonic liquid level detector of FIG. 2 in accordance with an exemplary embodiment of the present invention.

FIG. 4 illustrates a schematic of an ultrasonic liquid level detector to determine a height of a gas-liquid interface from an acoustic signal measurement in accordance with an exemplary embodiment of the present invention.

FIG. 5 illustrates graphically the measurements of Lamb wave amplitude as a function of an interface height for two different liquids in accordance with an exemplary embodiment of the present invention.

FIG. 6 illustrates a schematic of an ultrasonic liquid level detector to determine a height of a liquid-liquid interface from an echo time measurement in accordance with an exemplary embodiment of the present invention.

FIG. 7 illustrates a schematic of an ultrasonic liquid level detector to determine a height of a liquid-liquid interface from an echo time measurement in accordance with another exemplary embodiment of the present invention.

FIG. 8 illustrates graphically the measurements of an acoustic signal transit-time as a function of an interface height for two different liquids based on an echo time measurement in accordance with an exemplary embodiment of the present invention.

FIGS. 9A & 9B illustrate graphically measurements of acoustic signal transit-times of an acoustic pulse signal by a Lamb wave transducer of an ultrasonic liquid level detector of FIG. 6 in accordance with an exemplary embodiment of the present invention.

FIG. 10 illustrates a schematic of refraction angles into the two liquids forming the interface for a Lamb wave transducer of an ultrasonic liquid level detector of FIG. 6 in accordance with an exemplary embodiment of the present invention.

FIG. 11 illustrates a schematic of an ultrasonic liquid level detector to determine a height of a gas-liquid interface from an echo time measurement of a transit-time of an acoustic beam of an acoustic pulse signal in accordance with an exemplary embodiment of the present invention.

FIG. 12 illustrates a schematic of a hybrid ultrasonic liquid level detector to determine a height of a liquid-liquid interface from both an acoustic signal measurement and an echo time measurement in accordance with an exemplary embodiment of the present invention.

FIG. 13 illustrates a flow chart of a method for determining a liquid level in a container having a wall with an exterior surface from an acoustic signal measurement in accordance with an exemplary embodiment of the present invention.

FIG. 14 illustrates a flow chart of a method for determining a liquid level in a container having a wall with an exterior surface from an echo time measurement in accordance with an exemplary embodiment of the present invention.

FIG. 15 illustrates an arrangement to determine the speed of sound of the liquid in accordance with an exemplary embodiment of the present invention.

FIG. 16 illustrates a control unit for the sensor to control operation of the two transducers in accordance with an exemplary embodiment of the present invention.

### DETAILED DESCRIPTION

To facilitate an understanding of embodiments, principles, and features of the present invention, they are explained hereinafter with reference to implementation in illustrative embodiments. In particular, they are described in the context of being a contactless, clamp-on ultrasonic measuring system and a method for determining a height of a liquid level in a container from an acoustic signal or echo time measurement. Embodiments of the present invention, however, are not limited to use in the described devices or methods.

The components and materials described hereinafter as making up the various embodiments are intended to be illustrative and not restrictive. Many suitable components and materials that would perform the same or a similar function as the materials described herein are intended to be embraced within the scope of embodiments of the present invention.

Ultrasonic liquid level sensors typically detect the height of the liquid/gas or vapor interface by either one of two methods.
1. Transmitting a low frequency ultrasound pulse from the top of the tank through the air or vapor, then detecting the return echo off the vapor/liquid interface. The round trip time through the vapor indicates the distance between the sensor and the liquid surface, assuming the speed of sound along the path is known.
2. Transmitting a medium to high frequency ultrasonic pulse from the bottom of the tank through the liquid, reflecting the pulse off the liquid/vapor interface.

However, both of these methods involve inserting the transducers into a tank, which requires transducer materials and seals that are chemically compatible with the liquid or gas in the tank. For a liquid-liquid interface level application, the reflection off the interface may be very weak due to the high transmission coefficient through the interface formed by the lighter liquid “floating” on top of the heavier liquid. This makes it more difficult to detect the interface, and may also lead to a false indication from the liquid/gas boundary. Additionally, the tank bottom installation is more prone to failure due to the settling of solids (sediments) and is more difficult to service should a failure occur.

Accordingly, a contactless, clamp-on ultrasonic measuring system is described for the purpose of monitoring a fuel tank. It determines the liquid level with the aid of an acoustic signal or an echo time measurement of ultrasonic pulses, reflected at a liquid surface, in accordance with the echo sounding principle. Piezoelectric ultrasonic transducers are utilized as sensors or detection devices. In one embodiment, each piezoelectric ultrasonic transducer may be configured as a single component both for transmitting and for receiving ultrasonic pulses and measure the acoustic signal or echo time.

In one embodiment, clamp-on Lamb wave transducers are provided to completely avoid contact with potentially corrosive liquids. Embodiments of the present invention employ two different measurement principles using the same clamp-on Lamb wave transducers, thereby providing a degree of redundancy using dissimilar measurement principles typically required for Safety Instrumented (SIL) Systems. The clamp-on Lamb wave transducers may be configured to continuously monitor the level of liquid inside a holding tank, by measurement of the liquid/gas or liquid/liquid interface using non-intrusive clamp-on ultrasonic transducers. By installing transducers on the outside of a tank makes it possible to retrofit existing tanks which currently do not have level measuring devices installed.

Embodiments of the present invention ensure a higher reflection coefficient due to a significantly shallow incident angle of a clamp-on acoustic beam, where in most cases the beam would be critically reflected off a liquid-liquid interface. As with all clamp-on systems, servicing would not require draining the tank to replace or service the transducers. Since the embodiments of the present invention may employ dissimilar measurement approaches (transmit-time and acoustic amplitude) to measure the same liquid-liquid or liquid-gas interface, it makes a field device suitable for SIL3 (safety level 3) systems. In case of a narrow (small diameter) tank, with a lamb-wave transducer based system the dependency on the liquid's speed of sound is decreased or substantially eliminated.

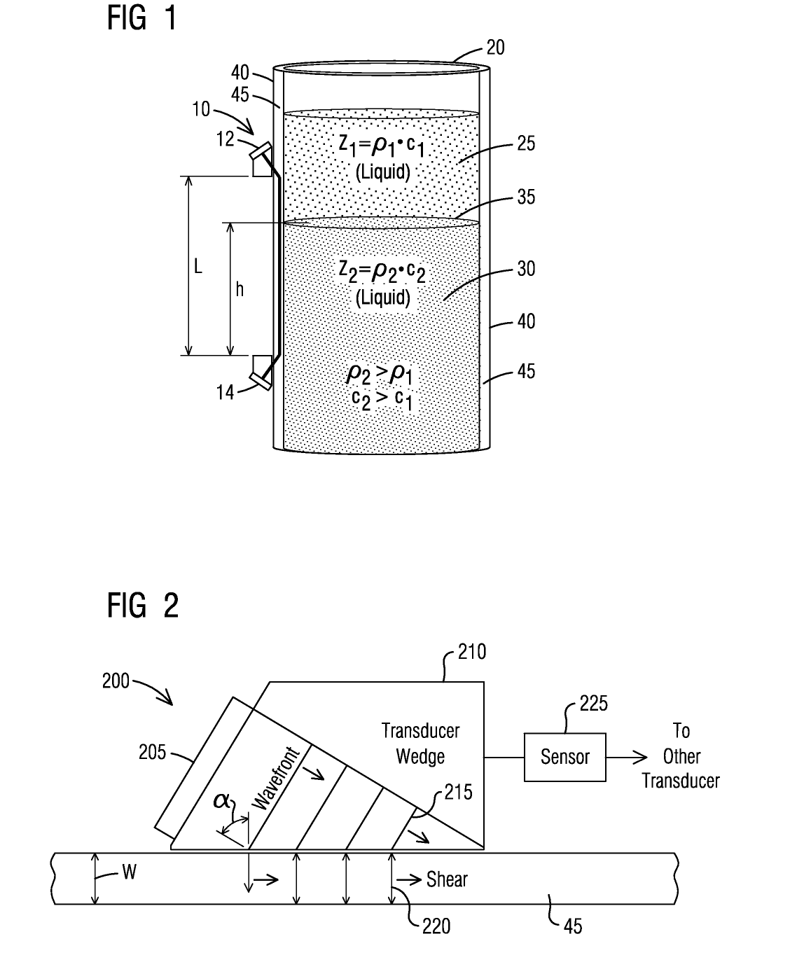

FIG. 1 illustrates a schematic of an ultrasonic liquid level detector 10 in accordance with an exemplary embodiment of the present invention. The ultrasonic liquid level detector 10 comprises a first ultrasonic transducer 12 and a second ultrasonic transducer 14 to determine a height of a liquid level in a container 20 capable of holding a first liquid 25 and a second liquid 30. For example, by using the first and second ultrasonic transducers 12, 14 to transmit and receive acoustic or sound waves or pulses the ultrasonic liquid level detector 10 may determine a height (h) of a liquid-liquid interface 35 between the first liquid 25 and the second liquid 30 within the container 20. Examples of the container 20 include a holding or processing tank.

As used herein, “liquid-liquid interface” refers to the physical boundary between two distinct liquids having dissimilar one or more properties (including but not limited to the liquids of dissimilar densities). The “ultrasonic liquid level detector” refers to a liquid level detector, as described herein, that corresponds to a detection technique based on sound or an acoustic signal, wave or pulse. The “ultrasonic liquid level detector,” in addition to the exemplary hardware description above, refers to a system that is configured to process a physical sound or an acoustic signal, wave or pulse, operated by a controller (including but not limited to an acoustic system controller, an ultrasonic system controller, and others). The ultrasonic liquid level detector can include multiple interacting systems, whether located together or apart, that together perform processes as described herein.

In one embodiment, the first and second ultrasonic transducers 12, 14 may operate at frequencies above 100 KHz, and more typically, in the 300-2000 KHz range.

The first and second ultrasonic transducers 12, 14 are configured to convert energy between electrical and acoustic energy forms. The first and second ultrasonic transducers 12, 14 may comprise transducer elements that are typically made of piezoelectric materials. The first and second ultrasonic transducers 12, 14 may use a single element or an array of elements of piezoelectric ceramic or composite materials to convert energy between acoustic and electrical forms.

According to one exemplary embodiment of the present invention, the first ultrasonic transducer 12 may be mounted on an exterior surface 40 of a wall 45 of the container 20. The first ultrasonic transducer 12 may be configured to transmit an acoustic pulse signal substantially through the wall 45 of the container 20 being in contact with the first liquid 25 and the second liquid 30. As can be seen in FIG. 1, the top surface of the second liquid 30 is indicative of the liquid-liquid interface 35. Likewise, the second ultrasonic transducer 14 may be mounted relative to the first ultrasonic transducer 12 on the exterior surface 40 of the wall 45 of the container 20 and aligned to receive the acoustic pulse signal from the first ultrasonic transducer 12. For example, the second ultrasonic transducer 14 may be disposed at a distance (L) from the first ultrasonic transducer 12 along a vertical height of the container 20, as shown in the FIG. 1.

Examples of the first and second ultrasonic transducers 12, 14 include electromechanical transducers having a piezoelectric crystal. Examples of the ultrasonic piezoelectric transducers 12, 14 include a Lamb Wave clamp-on transducer.

FIG. 2 illustrates a schematic of a Lamb Wave clamp-on transducer 200 of the ultrasonic liquid level detector 10 of FIG. 1 in accordance with an exemplary embodiment of the present invention. The Lamb Wave clamp-on transducer 200 may comprise a piezoelectric crystal 205 and a transducer wedge 210 which may be made of a plastic material. The Lamb Wave clamp-on transducer 200 uses Lamb waves to irradiate the wall 45 thickness such that they propagate non-dispersively along the length of the tank wall. By carefully controlling the excitation, desired Lamb waves may be generated of specific modes at specific frequencies that will propagate well and give sufficient amplitude or clean return “echoes.” One of ordinary skill in the art understands that the Lamb waves can be adjusted to many suitable values, for example based on properties of liquids, gases or vapours or the wall 45 materials of the container 20. One of ordinary skill in the art will appreciate that the Lamb Wave clamp-on transducer 200 can be embodied as separate acoustic components and/or can comprise additional electronic components not described herein.

In operation, the Lamb Wave clamp-on transducer 200 may be configured to provide transducer medium wavefronts 215. A shear wave 220 may be generated to travel in the wall 45 material. A Lamb wave may be established when the transducer frequency is selected to match the ½λ frequency of the wall 45. An acoustic wave thus travels down the wall 45 and Lamb wave transmission is provided. A transducer wedge angle α and a Lamb frequency required for proper Lamb wave operation in a steel wall may be empirically derived as indicated by equations 1 and 2 below:

$$\begin{matrix}α = {sin}^{- 1} ( \frac{{c}_{wedge}}{0.9 \cdot {c}_{wall\_shear }} ) \\ where \\ {c}_{wall\_shear } = Shear wave velocity in wall , \\ {c}_{wedge } = wedge material sound velocity & Eq . 1 \\ Lamb Freg = \frac{{c}_{wall\_long}}{2 w} \\ where \\ {c}_{wall\_long} = Longitudinal wave velocity in wall , \\ w = thickness of the wall & Eq . 2\end{matrix}$$

In operation, the ultrasonic liquid level detector 10 determines the height (h) of a liquid-liquid interface 35 between the first liquid 25 and the second liquid 30 within the container 20 from an acoustic signal measurement by a sensor 225.

In one embodiment, the sensor 225 electronics may include analog and digital components. In particular, the sensor 225 electronics may include a transmit circuit, an analog to digital converter (ADC), a digital signal processor (DSP). The sensor 225 electronics may further include a memory such as a read-only memory (“ROM”) and/or a random access memory (“RAM”) and one or more input/output (“I/O”) interface(s). The ROM, RAM are memories for storing computer-executable instructions executable by the processor. The computer-executable instructions may be stored as software code components on appropriate computer-readable medium or storage device. In one exemplary embodiment, the computer-executable instructions may be code lines of software programming languages such as C, C++, Java, JavaScript, or any other programming or scripting code. The sensor 225 electronics may calculate the height (h) of the liquid-liquid interface 35 based on the acoustic measurements.

Acoustic energy travelling from one transducer and received by the other transducer may be measured by detecting a signal amplitude or a signal power of an acoustic pulse signal or signature. As it travels through the wall 45 of the container 20. The liquid inside the container 20 may absorb some of the acoustic energy. However, if the container 20 is empty the acoustic pulse signal will travel un-impeded from one transducer to another transducer as there will be a little loss of energy. But despite some scattering of the acoustic pulse signal inside the wall 45 of the container 20, the second ultrasonic transducer 14 will receive a substantially strong acoustic signal from the first ultrasonic transducer 12 of the ultrasonic liquid level detector 10. The longer a distance between the first ultrasonic transducer 12 and the second ultrasonic transducer 14, the attenuation of the acoustic pulse signal will be larger.

A holding or processing tank may contain two liquids having different densities. A pair of Lamb wave clamp-on transducers may be installed on a side of the tank. The Lamb wave clamp-on transducers may transmit and receive acoustic signals that travel along the wall of the tank. The amplitude of the received acoustic pulse will be dependent on the acoustic impedance of the liquid in contact with the wall 45 (i.e. higher density liquids absorb more acoustic energy from the tank wall).

The techniques described herein can be particularly useful for determining a height of a liquid-liquid interface in a holding or processing tank that may contain two liquids having different densities. While particular embodiments are described in terms of Lamb wave clamp-on transducers, the techniques described herein are not limited to Lamb wave clamp-on transducers but can also use transducers with other sound propagating modes, such as shear wave transducers, although this type of wave propagation is more dispersive than the Lamb wave mode.

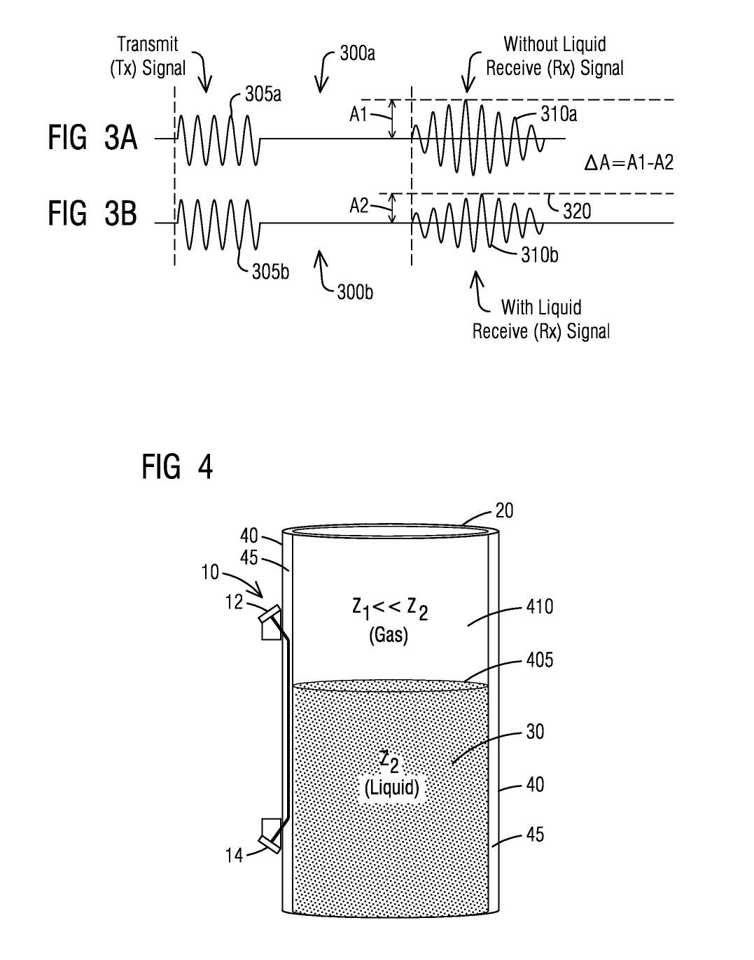

FIGS. 3A & 3B illustrate graphically measurements of an acoustic attenuation of signal amplitude (A1+A2=ΔA) of an acoustic pulse signal 300a by the sensor 225 coupled to the Lamb wave clamp-on transducer 200 of the ultrasonic liquid level detector 10 of FIG. 2 in accordance with an exemplary embodiment of the present invention.

Referring to FIG. 3A, the acoustic pulse signal 300a includes a transmit (TX) signal 305a and a received (RX) signal 310a sensed via a sensor like the sensor 225 coupled to the second ultrasonic transducer 14 without the first liquid 25 and the second liquid 30 being present in the container 20. Referring to FIG. 3B, an acoustic pulse signal 300b includes a transmit (TX) signal 305b and a received (RX) signal 310b sensed via a sensor like the sensor 225 coupled to the second ultrasonic transducer 14 with the first liquid 25 and the second liquid 30 being present in the container 20. The acoustic attenuation of signal amplitude ΔA of the acoustic pulse signal 300a represents a difference between a maximum signal amplitude of the received (RX) signal 310a and a maximum signal amplitude 320 of the received (RX) signal 310b.

In operation, the second ultrasonic transducer 14 being the Lamb wave clamp-on transducer 200 is configured to receive the acoustic pulse signal 300b travelled via the wall 45 of the container 20 to measure the acoustic attenuation of signal amplitude ΔA of the acoustic pulse signal 300b dependent upon a first acoustic impedance Z₁ (Z₁=ρ₁·c₁; ρ₁=density of the first liquid 25 and c₁=sound speed in the first liquid 25) of the first liquid 25 and a second acoustic impedance Z₂ (Z₂=ρ₂·c₂; ρ₂=density of the second liquid 30 and c₂=sound speed in the second liquid 30 where ρ₂>ρ₁ and c₂>c₁) of the second liquid 30 in contact with the wall 45 of the container 20. The second ultrasonic transducer 14 determines the height (h) of the liquid-liquid interface 35 being indicative of the liquid level of the first liquid 25 in the container 20 based on the measured acoustic attenuation of the signal amplitude ΔA of the received (RX) signal 310b.

FIG. 4 illustrates a schematic of the ultrasonic liquid level detector 10 to determine a height of a gas-liquid interface 405 from an acoustic signal measurement in accordance with an exemplary embodiment of the present invention. The second ultrasonic transducer 14 is configured to receive the acoustic pulse signal 300b travelled via the wall 45 of the container 20 and via a sensor line the sensor 225 of FIG. 2 measures the acoustic attenuation of signal amplitude ΔA of the acoustic pulse signal 300b dependent upon the first acoustic impedance Z₁ of a gas 410 and the second acoustic impedance Z₂ of the second liquid 30. The first acoustic impedance Z₁ of the gas 410 and the second acoustic impedance Z₂ has a relationship Z₁<<Z₂. The second ultrasonic transducer 14 determines a height of the gas-liquid interface 405 being indicative of a liquid level of the second liquid 30 in the container 20 based on the measured acoustic attenuation of the signal amplitude ΔA of the received (RX) signal 310b.

For two liquids having known acoustic impedances, the relationship between the signal amplitude (A) and the height of the liquid-liquid interface (h) can be expressed by:

$$A ( h ) = {{A}_{0} ( \frac{{Z}_{pipe} - \frac{{Z}_{1} \cdot ( L - h ) + {Z}_{2} \cdot ( h )}{L}}{{Z}_{pipe} + \frac{{Z}_{1} \cdot ( L - h ) + {Z}_{2} \cdot ( h )}{L}} )}^{n} \qquad Eq . 3$$

where:
A₀=receive amplitude with an empty tank
L=distance between transducers
Z₁ & Z₂=acoustic impedance of the first liquid and second liquid
Zₚᵢₚₑ=acoustic impedance of the tank wall (e.g. for stainless steel)
h=height of liquid/liquid interface
n=number of tank wall reflections between transducers (≈L/wt) where wt=tank wall thickness)

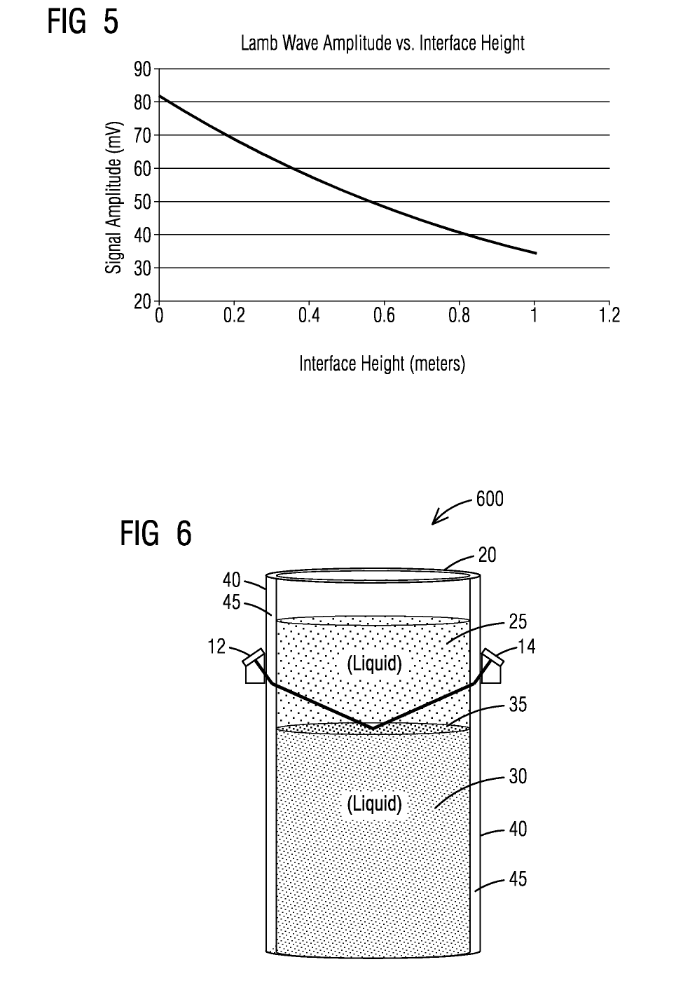

FIG. 5 illustrates graphically measurements of Lamb wave amplitude as a function of an interface height for two different liquids in accordance with an exemplary embodiment of the present invention. As can be seen, the signal amplitude is higher when the height h is less. This is so because when the liquid level height h is lower, the high impedance liquid 30 is then less in contact with the wall 45. Therefore, the total liquid impedance will be less, thereby increasing the signal amplitude. In the case of a gas-liquid interface, the graph of FIG. 5 drops much more quickly, therefore greater sensitivity of the interface height may be obtained.

The relationship shown by Eq. 3 is shown in the graph of FIG. 5 for L=1 meter, Z₁=1.00e6 and Z₂=1.35e6 Rayl (kg/s/m2). The Eq. 3 can be applied to the gas-liquid interface case shown in FIG. 4. In this case the significantly larger acoustic impedance difference between air and liquid would result in an even greater sensitivity to liquid level. For known liquids the ultrasonic liquid level detector 10 may improve the accuracy of a level measurement by compensating the density and sound speed of each liquid component with changes in liquid temperature.

The above set forth level measurement technique may be calibrated with the container 20 emptied below the lowest transducer, i.e., the second ultrasonic transducer 14. The calibration may be performed with the liquid-liquid interface 35 above the highest transducer, i.e., the first ultrasonic transducer 12.

Another level measurement approach uses a pulse echo technique with clamp-on transducers instead of insertion type transducers. An ultrasonic liquid level detector based on this level measurement approach applied to the liquid-liquid interface 35 is described next. One notable difference between a clamp-on based level measurement and a level measurement using insertion type transducers is the stronger reflection expected from the liquid-liquid interface 35.

FIG. 6 illustrates a schematic of an ultrasonic liquid level detector 600 to determine a height of a liquid-liquid interface from an echo time measurement in accordance with an exemplary embodiment of the present invention. The ultrasonic liquid level detector 600 comprises the first ultrasonic transducer 12 and the second ultrasonic transducer 14. The first and second ultrasonic transducers 12, 14 may be configured to transmit and receive acoustic or sound waves or pulses to determine a height of the liquid-liquid interface 35 between the first liquid 25 and the second liquid 30 within the container 20.

Consistent with one exemplary embodiment of the present invention, the first ultrasonic transducer 12 may be mounted on the exterior surface 40 of the wall 45 of the container 20. Likewise, the second ultrasonic transducer 14 may be mounted relative to the first ultrasonic transducer 12 on the exterior surface 40 of the wall 45 of the container 20 and aligned to receive the acoustic pulse signal from the first ultrasonic transducer 12. For example, the second ultrasonic transducer 14 may be disposed at a distance from the first ultrasonic transducer 12 along a horizontal width of the container 20, as shown in the FIG. 6.

The first ultrasonic transducer 12 may be configured to transmit an acoustic pulse signal to a liquid surface of the second liquid 30. The second ultrasonic transducer 14 may receive the acoustic pulse signal travelled from the liquid surface of the second liquid 30. To measure a signal transit-time of an acoustic beam of the received acoustic pulse signal reflected from the liquid surface of the second liquid 30, a sensor such as the sensor 225 of FIG. 2 may be coupled to the second ultrasonic transducer 14. The sensor may be integrated with the transducer 14. In this way, the sensor 225 and the transducers 12 and 14 may form a single electronic unit that transmits and receives the signals, since the two events may be precisely synchronized. The first ultrasonic transducer 12 and the second ultrasonic transducer 14 may are configured, as shown in FIG. 6, such that the acoustic beam of the acoustic pulse signal travels from the first ultrasonic transducer 12 to the second ultrasonic transducer 14 on a sound path being at an acute angle to the liquid surface of the second liquid 30. In this way, an ultrasonic liquid level detector determines the height of the liquid-liquid interface 35 based on the measured signal transit-time of the acoustic beam of the received acoustic pulse signal.

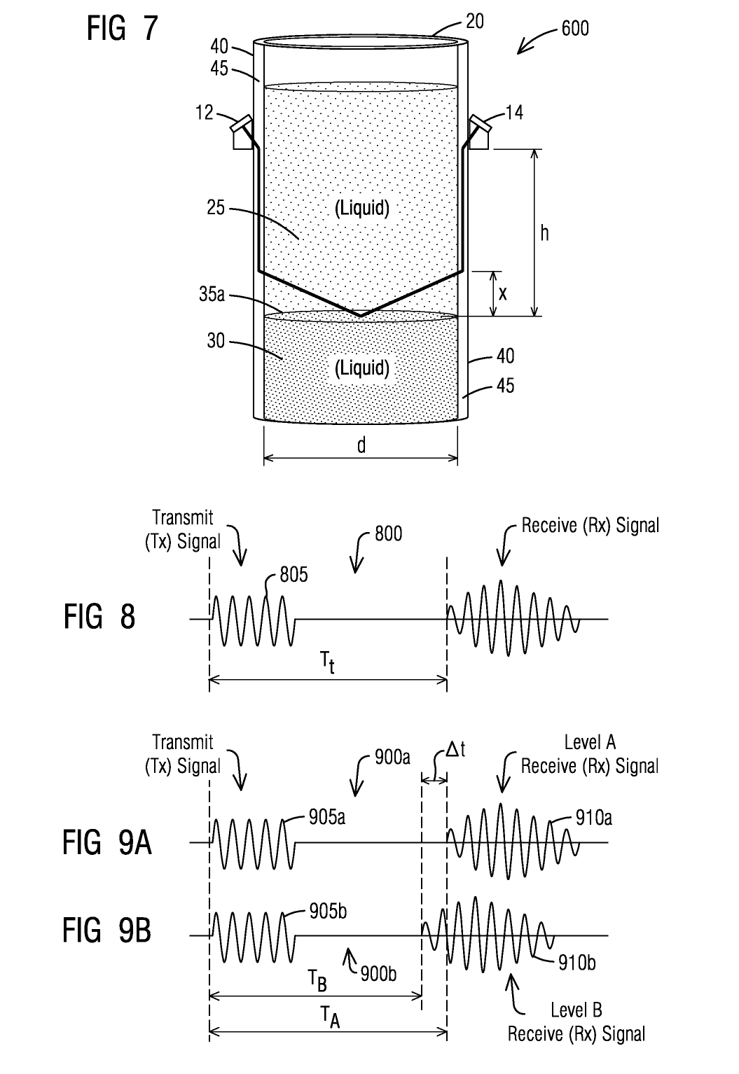

FIG. 7 illustrates a schematic of the ultrasonic liquid level detector 600 to determine a height (h) of a liquid-liquid interface 35a from an echo time measurement in accordance with another exemplary embodiment of the present invention. As the level of the interface changes the angle of refraction stays the same but the amount of travel within the wall 45 changes or increases with the drop in the height of the interface. If using a tank bottom ultrasonic level detector a first acoustic pulse will be reflected off a liquid-liquid interface and a second acoustic pulse will be reflected off a gas-liquid interface. However, the amount of energy reflected off the liquid-liquid interface will be relatively weak as it is a direct normal transmission so most of the energy will be transmitted to liquid on the top and only a small portion will be reflected back so will not get a very strong signal as compared to the ultrasonic liquid level detector 600 including the Lamb wave clamp-on transducers 200.

FIG. 8 illustrates graphically measurements of a transit-time (Tₜ) of an acoustic pulse signal 800 as a function of an interface height for two different liquids based on an echo time measurement in accordance with an exemplary embodiment of the present invention. The acoustic pulse signal 800 includes a transmit (TX) signal 805 and a received (RX) signal 810 sensed via a sensor like the sensor 225 coupled to the second ultrasonic transducer 14 of the ultrasonic liquid level detector 600, as shown in FIG. 6.

FIGS. 9A & 9B illustrate graphically measurements of acoustic signal transit-times of an acoustic pulse signal by the Lamb wave clamp-on transducer 200 of the ultrasonic liquid level detector 600 of FIG. 6 in accordance with an exemplary embodiment of the present invention. Referring to FIG. 9A, an acoustic pulse signal 900a includes a transmit (TX) signal 905a and a received (RX) signal 910a sensed via a sensor like the sensor 225 coupled to the second ultrasonic transducer 14 with the first liquid 25 and the second liquid 30 being present in the container 20 and the liquid-liquid interface 35 is at a Level A. A transit-time (T_{A}) of the transmit (TX) signal 905a as a function of an interface height for two different liquids may be measured by sensing the time of receipt of the received (RX) signal 910a after the transmission of the transmit (TX) signal 905a by using a sensor like the sensor 225 coupled to the second ultrasonic transducer 14.

Referring to FIG. 9B, an acoustic pulse signal 900b includes a transmit (TX) signal 905b and a received (RX) signal 910b sensed via a sensor like the sensor 225 coupled to the second ultrasonic transducer 14 with the first liquid 25 and the second liquid 30 being present in the container 20. The liquid-liquid interface 35 is at a Level B which is higher than the Level A. A transit-time (T_{B}) of the transmit (TX) signal 905b as a function of an interface height for two different liquids may be measured by sensing the time of receipt of the received (RX) signal 910b after the transmission of the transmit (TX) signal 905b by using a sensor like the sensor 225 coupled to the second ultrasonic transducer 14.

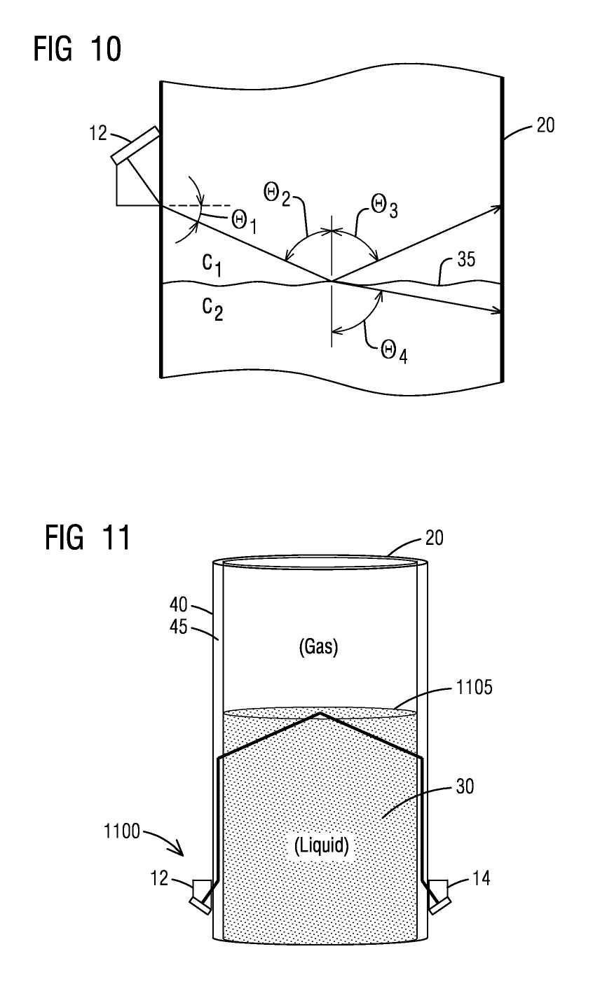

FIG. 10 illustrates a schematic of refraction angles into the two liquids forming the interface for the Lamb wave clamp-on transducer 200 of the ultrasonic liquid level detector 600 of FIG. 6 in accordance with an exemplary embodiment of the present invention. FIG. 10 shows a hypothetical case where the two liquids have a sound speed of 1250 and 1350 m/s. The refraction angles (θₙ) are based on the phase velocity of the Lamb wave clamp-on transducer 200 (in this case 2874 m/s) and the sound speed or velocity (c) in each liquid.

$${θ}_{1} = asin ( \frac{{c}_{1}}{{V}_{phase}} ) \qquad Eq . 4$$

where Vₚₕₐₛₑ=the phase velocity of the transducer; a=arcsine.

$$\begin{matrix}{θ}_{2} = {θ}_{3} = \frac{π}{2} - {θ}_{1} & Eq . 5 \\ {θ}_{4} = asin ( \frac{{c}_{2}}{{c}_{1}} sin ( \frac{π}{2} - asin ( \frac{{c}_{1}}{{V}_{phase}} ) ) ) & Eq . 6\end{matrix}$$

The critical angle, where substantially all sound energy is reflected back into the lower density liquid 25, is reached when the sound velocity (c₂) of the higher density liquid 30 exceeds the value given by the equation below:

$${c}_{2 ( @ {θ}_{4 critical} )} = \frac{{c}_{1}}{sin ( \frac{π}{2} - asin ( \frac{{c}_{1}}{{V}_{phase }} ) )} \qquad Eq . 7$$

where θ_{4critical}=the critical angle

For this level measurement approach the pulse echo transit-time is related to the height of the interface (h) by:

$$\begin{matrix}Time ( h ) = 2 \cdot {T}_{fixed} + 2 \cdot \frac{x}{{c}_{1} \cdot sin {θ}_{1}} + 2 \cdot \frac{h - x}{{V}_{group}} \\ where \text{:} & Eq . 8 \\ x = \frac{d}{2} \cdot tan {θ}_{1} & Eq . 9\end{matrix}$$

and T_{fixed}=Fixed time in the transducer wedge; V_{group}=the phase velocity of the wall; h, x, d=inside diameter of the container 20 are shown in FIG. 7

As such, θ₄ represents the transmitted angle or refracted angle. In some embodiments, θ₄ is desired to be 90° as being the critical angle having all the acoustic energy reflected of the liquid-liquid interface 35. The above set forth approach may also be utilized for detecting the level of a gas-liquid interface.

FIG. 11 illustrates a schematic of an ultrasonic liquid level detector 1100 to determine a height of a gas-liquid interface 1105 from an echo time measurement of a transit-time of an acoustic beam of an acoustic pulse signal in accordance with an exemplary embodiment of the present invention. This method relies on a significant acoustic signal path length through a portion of the tank wall 45 which is in contact with the second liquid 30, therefore it is expected that the signal amplitude will be significantly attenuated due to liquid loading. For this reason the change in liquid level should be somewhat limited, making this approach more suitable for applications that require a nearly constant level in the tank or container 20.

Consistent with one embodiment, the above set forth two independent measurement techniques of acoustic amplitude measurement and echo time measurement may be combined to achieve a more robust level indication based on double measurements of the same liquid level. Such diverse measurement approaches are typically required for Safety Instrumented Systems. In this case, an agreement between the two methods (amplitude and transit-time) provides a much higher confidence in the delivered level indication.

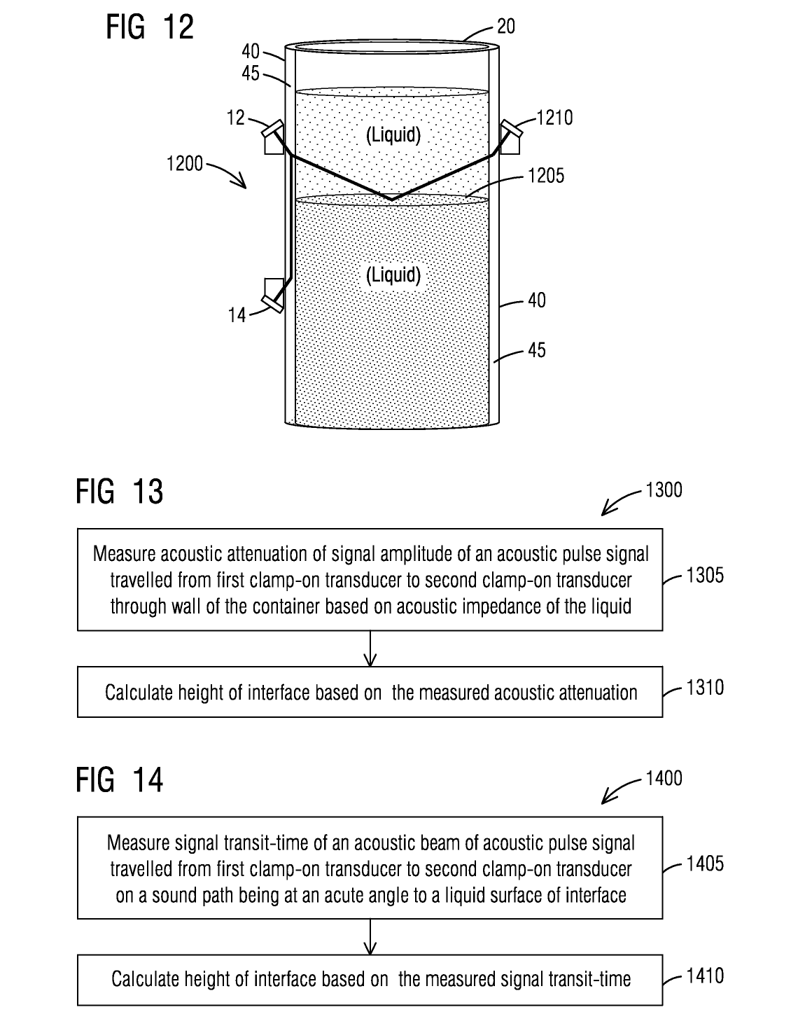

FIG. 12 illustrates a schematic of a hybrid ultrasonic liquid level detector 1200 to determine a height of a liquid-liquid interface 1205 from both an acoustic signal measurement and an echo time measurement in accordance with an exemplary embodiment of the present invention. The hybrid ultrasonic liquid level detector 1200 comprises the first ultrasonic transducer 12, the second ultrasonic transducer 14 and a third ultrasonic transducer 1210. The first, second and third ultrasonic transducers 12, 14, 1210 may be configured to transmit and receive acoustic or sound waves or pulses to determine the height of the liquid-liquid interface 1205 between the first liquid 25 and the second liquid 30 within the container 20.

FIG. 13 illustrates a flow chart of a method 1300 for determining a liquid level in the container 20 having the wall 45 with the exterior surface 40 from an acoustic signal measurement in accordance with an exemplary embodiment of the present invention. Reference is made to the elements and features described in FIGS. 1-12. It should be appreciated that some steps are not required to be performed in any particular order, and that some steps are optional.

In step 1305, an acoustic attenuation of signal amplitude of an acoustic pulse signal may be measured by an ultrasonic transducer of an ultrasonic liquid level detector. For example, the acoustic pulse signal may be travelled from the first ultrasonic transducer 12 to the second ultrasonic transducer 14 substantially through the wall 45 of the container 20 being in contact with the first liquid 25, as shown in FIG. 1. The acoustic attenuation of the signal amplitude of the acoustic pulse signal will be based on at least an acoustic impedance of the first liquid 25 while the first and second ultrasonic transducers 12, 14 may be mounted on the exterior surface 40 of the wall 45 of the container 20. In step 1310, the height of a gas-liquid interface or a liquid-liquid interface being indicative of a liquid level of the first liquid 25 in the container 20 may be calculated based on the measured acoustic attenuation of the signal amplitude of the acoustic pulse signal by the ultrasonic liquid level detector 10.

In some embodiments of the present invention, clamp-on acoustic transducers such as the first and second ultrasonic transducers 12, 14 of the ultrasonic liquid level detector 10 may be used for continuous liquid level indication based on an ultrasound signal attenuation detection in a tank. The ultrasonic liquid level detector 10 provides an ability to detect the level of an emulsified liquid-liquid interface using ultrasound attenuation by use of the Lamb waves. Likewise, the ultrasonic liquid level detector 10 also improves an ability to detect the height of the interface between two liquids having different densities. The use of two diverse level measurement approaches as set forth above for measuring a liquid level within a same device such as the ultrasonic liquid level detector 10 may be provided, as shown in FIG. 12. A process control solution where the liquid level in a tank must be maintained within a narrow range may also be provided.

FIG. 14 illustrates a flow chart of a method 1400 for determining a liquid level in the container 20 having the wall 45 with the exterior surface 40 from an echo time measurement in accordance with an exemplary embodiment of the present invention. Reference is made to the elements and features described in FIGS. 1-12. It should be appreciated that some steps are not required to be performed in any particular order, and that some steps are optional.

In step 1405, a signal transit-time of an acoustic beam of an acoustic pulse signal may be measured by an ultrasonic transducer of an ultrasonic liquid level detector. This acoustic pulse signal may have travelled from, e.g., the first ultrasonic transducer 12 to the second ultrasonic transducer 14 on a sound path being at an acute angle to a liquid surface of a liquid level of the first liquid 25 in the container 20. The liquid surface is indicative of a gas-liquid interface or a liquid-liquid interface while the first and second ultrasonic transducers 12, 14 may be mounted on the exterior surface 40 of the wall 45 of the container 20, as shown in FIG. 1. In step 1410, the height of the gas-liquid interface or the liquid-liquid interface may be calculated based on the measured signal transit-time of the acoustic beam of the acoustic pulse signal by the ultrasonic liquid level detector 10.

In some embodiments of the present invention, an angled sound path instead of a vertical path may provide an improved sensitivity to low reflecting layers (small density differences) because the acoustic beam can be critically reflected at the liquid-liquid interface 35.

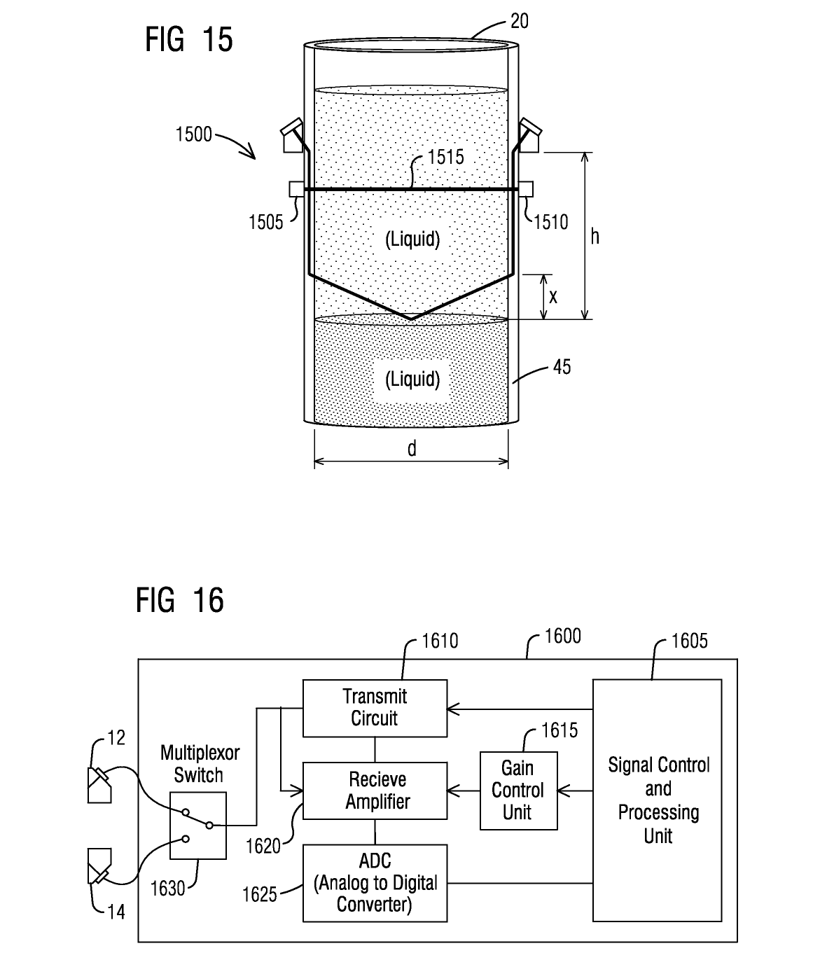

FIG. 15 illustrates an arrangement 1500 to determine the speed of sound of the liquid in accordance with an exemplary embodiment of the present invention. Two transducers 1505, 1510 such as piezoelectric ultrasonic transducers may be used. The transducer 1505 may transmit normally through the pipe wall 45 as a longitudinal wave 1515 (not a Lamb wave). Because the beam is normal to the pipe wall 45, there are no refractions and therefore the path length is constant. By transmitting a longitudinal wave normal to the wall 45 of the container 20 which provides an ultrasound path with a constant length, the speed of sound c₁ of the liquid 25 may be determined.

In the illustrated embodiments, the signal processing is advantageously deployed in a way that enables a possibility to combining amplitude and phase effects in the different path configurations in a target level meter.

FIG. 16 illustrates a control unit 1600 for the sensor 225 to control operation of the transducers 12 and 14 in accordance with an exemplary embodiment of the present invention. The control unit 1600 comprises a signal control and processing unit 1605 coupled to a transmit circuit 1610 that transmits a signal to the transducers 12, 14. The control unit 1600 further comprises a gain control unit 1615 coupled to a receive amplifier 1620. The control unit 1600 further comprises an analog to digital converter (ADC) 1625 to receive a signal from the receive amplifier 1620 and provide output to the signal control and processing unit 1605. The control unit 1600 further comprises a multiplexor switch 1630 coupled to the transmit circuit 1610 and the two transducers 12 and 14. The multiplexor switch 1630 switchably connects the control unit 1600 to the two transducers 12 and 14.

While embodiments of the present invention have been disclosed in exemplary forms, it will be apparent to those skilled in the art that many modifications, additions, and deletions can be made therein without departing from the spirit and scope of the invention and its equivalents, as set forth in the following claims.

Embodiments and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure embodiments in detail. It should be understood, however, that the detailed description and the specific examples, while indicating preferred embodiments, are given by way of illustration only and not by way of limitation. Various substitutions, modifications, additions and/or rearrangements within the spirit and/or scope of the underlying inventive concept will become apparent to those skilled in the art from this disclosure.

As used herein, the terms “comprises,” “comprising,” “includes,” “including,” “has,” “having” or any other variation thereof, are intended to cover a non-exclusive inclusion. For example, a process, article, or apparatus that comprises a list of elements is not necessarily limited to only those elements but may include other elements not expressly listed or inherent to such process, article, or apparatus.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms.

In the foregoing specification, the invention has been described with reference to specific embodiments. However, one of ordinary skill in the art appreciates that various modifications and changes can be made without departing from the scope of the invention. Accordingly, the specification and figures are to be regarded in an illustrative rather than a restrictive sense, and all such modifications are intended to be included within the scope of invention.

Although the invention has been described with respect to specific embodiments thereof, these embodiments are merely illustrative, and not restrictive of the invention. The description herein of illustrated embodiments of the invention is not intended to be exhaustive or to limit the invention to the precise forms disclosed herein (and in particular, the inclusion of any particular embodiment, feature or function is not intended to limit the scope of the invention to such embodiment, feature or function). Rather, the description is intended to describe illustrative embodiments, features and functions in order to provide a person of ordinary skill in the art context to understand the invention without limiting the invention to any particularly described embodiment, feature or function. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Respective appearances of the phrases “in one embodiment,” “in an embodiment,” or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Although the steps, operations, or computations may be presented in a specific order, this order may be changed in different embodiments. In some embodiments, to the extent multiple steps are shown as sequential in this specification, some combination of such steps in alternative embodiments may be performed at the same time.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention.

It will also be appreciated that one or more of the elements depicted in the drawings/figures can also be implemented in a more separated or integrated manner, or even removed or rendered as inoperable in certain cases, as is useful in accordance with a particular application.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component.

What is claimed is:

1. A method for determining a liquid level in a container having a wall with an exterior surface from an acoustic signal measurement, the method comprising:
measuring an acoustic attenuation of a signal amplitude of an acoustic pulse signal travelled from a first transducer to a second transducer substantially through the wall of the container being in contact with a first liquid based on an acoustic impedance of the first liquid in contact with the wall of the container, wherein the first and second transducers are mounted on the exterior surface of the wall of the container; and
calculating a height of a gas-liquid interface or a liquid-liquid interface being indicative of a liquid level of the first liquid in the container based on the measured acoustic attenuation of the signal amplitude of the acoustic pulse signal.

2. The method of claim 1, further comprising:
transmitting the acoustic pulse signal from the first transducer to the second transducer; and
receiving the acoustic pulse signal travelled via the wall of the container at the second transducer, wherein the second transducer is mounted relative to the first transducer on the exterior surface of the wall of the container and aligned to receive the acoustic pulse signal.

3. The method of claim 1, wherein the first and second transducers are an ultrasonic transducer.

4. The method of claim 3, wherein the ultrasonic transducer is a Lamb wave acoustic transducer.

5. The method of claim 1, wherein the second transducer is disposed at a distance from the first transducer along a vertical height of the container.

6. A method for determining a liquid level in a container having a wall with an exterior surface from an echo time measurement, the method comprising:
measuring a signal transit-time of an acoustic beam of an acoustic pulse signal travelled from a first transducer to a second transducer on a sound path being at an acute angle to a liquid surface of a liquid level of a first liquid in the container, the liquid surface indicative of a gas-liquid interface or a liquid-liquid interface, wherein the first and second transducers are mounted on the exterior surface of the wall of the container; and
calculating a height of the gas-liquid interface or the liquid-liquid interface being indicative of the liquid level of the first liquid in the container based on the measured signal transit-time of the acoustic beam of the acoustic pulse signal.

7. The method of claim 6, further comprising:
transmitting the acoustic pulse signal from the first transducer substantially to the liquid surface of the liquid level of the first liquid in the container; and
receiving reflection of the acoustic pulse signal from the liquid surface at the second transducer, wherein the second transducer is mounted relative to the first transducer on the exterior surface of the wall of the container and aligned to receive the acoustic pulse signal.

8. The method of claim 6, wherein the acoustic beam of the received acoustic pulse signal is critically reflected of the liquid surface of the first liquid to direct substantially all acoustic energy of the reflected acoustic pulse signal to the second transducer.

9. The method of claim 6, wherein the first and second transducers are an ultrasonic transducer, wherein the ultrasonic transducer is a Lamb wave acoustic transducer.

10. The method of claim 9, further comprising:
transmitting a longitudinal wave normal to the wall of the container which provides an ultrasound path with a constant length to determine the speed of sound of the first liquid.

11. The method of claim 6, wherein the second transducer is disposed at a distance from the first transducer along a horizontal width of the container.

12. An ultrasonic liquid level detector comprising:
a first transducer mounted on an exterior surface of a wall of a container capable of holding a first liquid,
wherein the first transducer is configured to transmit an acoustic pulse signal substantially through the wall of the container being in contact with the first liquid or substantially to a liquid surface of a liquid level of the first liquid in the container, the liquid surface being indicative of a gas-liquid interface or a liquid-liquid interface; and
a second transducer mounted relative to the first transducer on the exterior surface of the wall of the container and aligned to receive the acoustic pulse signal from the first transducer,
wherein the second transducer is configured to:
receive the acoustic pulse signal travelled via the wall of the container to measure an acoustic attenuation of a signal amplitude of the acoustic pulse signal dependent upon an acoustic impedance of the first liquid in contact with the wall of the container to determine a height of the gas-liquid interface or the liquid-liquid interface being indicative of the liquid level of the first liquid in the container based on the measured acoustic attenuation of the signal amplitude of the received acoustic pulse signal or
receive the acoustic pulse signal travelled from the liquid surface to measure a signal transit-time of an acoustic beam of the received acoustic pulse signal reflected from the liquid surface and travelled from the first transducer to the second transducer on a sound path being at an acute angle to the liquid surface to determine the height of the gas-liquid interface or the liquid-liquid interface based on the measured signal transit-time of the acoustic beam of the received acoustic pulse signal.

13. The ultrasonic liquid level detector of claim 12, wherein the acoustic beam of the received acoustic pulse signal is critically reflected of the liquid surface of the first liquid to direct substantially all acoustic energy of the reflected acoustic pulse signal to the second transducer.

14. The ultrasonic liquid level detector of claim 12, wherein the first and second transducers are an ultrasonic transducer.

15. The ultrasonic liquid level detector of claim 14, wherein the ultrasonic transducer is a Lamb wave acoustic transducer.

16. The ultrasonic liquid level detector of claim 12, wherein the second transducer is disposed at a distance from the first transducer along a vertical height of the container.

17. The ultrasonic liquid level detector of claim 12, wherein the second transducer is disposed at a distance from the first transducer along a horizontal width of the container.

18. The ultrasonic liquid level detector of claim 12, further comprising:
a third transducer configured to receive another acoustic pulse signal from the first transducer.

19. The ultrasonic liquid level detector of claim 18, wherein the third transducer is an ultrasonic transducer.

20. The ultrasonic liquid level detector of claim 19, wherein the ultrasonic transducer is a Lamb wave acoustic transducer.
